(19) United States
(12) Patent Application Publication
(10) Pub. No.: US 2026/0118735 A1
(43) Pub. Date: Apr. 30, 2026

(54) Purely Optical XOR Logic Gate with Comprising Materials

(71) Applicant: Julieanne H Fisher, Santa Rosa, CA (US)

(72) Inventors: Mark James Newland, Dubuque, IA (US); Julieanne H Fisher, Santa Rosa, CA (US)

(21) Appl. No.: 19/321,977

(22) Filed: Sep. 8, 2025

(51) Int. Cl. G02F 3/02

(52) U.S. Cl. CPC G02F 3/024

(57) ABSTRACT

A purely optical XOR gate is disclosed, implemented entirely within fiber optic channels and without any electrical control elements. Two digital data light inputs, A and B, are each amplified, split, and partially converted to higher-frequency control light via frequency doublers. The control light from each input is directed into a corresponding right-angle Data Light Extinguisher (DLE) intersecting the opposite channel, where it extinguishes simultaneous “1” pulses by inducing a waveguide cutoff through piezoelectric deformation. The remaining data light pulses, representing conditions where only A or only B is high, are combined into a single output channel. This architecture operates in parallel optical paths without reflections or high voltage, enabling high-speed, low-loss XOR logic entirely in the photonic domain.

### FIELD OF THE INVENTION

This invention relates to a method of and apparatus for using a fiber optic XOR logic gate using optically active materials. XOR gates are used in computer and control device logic for the designing and programming of decision-making circuits. The materials of this XOR gate allow all optical computational circuits to be designed.

### DESCRIPTION OF PRIOR ART

Much more information can be carried in fiber optic cables and light channels than in electrical wires. Many frequencies of light may be transmitted all carrying separate information or data in a fiber optic cable. The number of frequencies that may be sent on a single electrical wire is much more limited because the current waves on the wire do not stay separate because they share the same electrons. The electromagnetic fields of the light frequencies in a fiber optic cable or channel stay closely coupled and may be separated back to give their individual data stream. It is desirable therefore to develop fully optical logic and fully optical computing. It is to this end many patents have been written.

One patent that is an example of this is U.S. Pat. No. 8,582,931 by G. Allen Vawter, which teaches “Optical XOR Gate” which was published Nov. 12, 2013. The XOR gate is a combination of an OR Gate, a NAND Gate (inverted AND Gate), and an AND Gate. Both optical outputs are provided to the OR Gate and the NAND Gate. The output from the OR gate and NAND Gate are then provided to the AND Gate of which the output is an XOR operation on the two original signals. [Abstract: An optical XOR gate is formed as a photonic integrated circuit (PIC) from two sets of optical waveguide devices on a substrate, with each set of the optical waveguide devices including an electroabsorption modulator electrically connected in series with a waveguide photodetector. The optical XOR gate utilizes two digital optical inputs to generate an XOR function digital optical output. The optical XOR gate can be formed from III-V compound semiconductor layers which are epitaxially deposited on a III-V compound semiconductor substrate and operates at a wavelength in the range of 0.8-2.0 μm.]

A second patent that is an example of prior art in the gate technology is United Sates U.S. Pat. No. 8,330,960 by Ullrich et al., which teaches “All Optical and Hybrid Reflection Switch at a Semiconductor/Glass Interface Due to Laser Beam Intersection” which was published Dec. 11, 2012. In column 10 line 30 of Ullrich's patent, he tells how gates may be made using his laser crossing technology. Ullrich's patent modulates one beam of laser light with another focused on the same point on a reflective surface. Both laser lights reflect at an angle from the perpendicular and one beam influences the brightness of the other beam. These arrangements are not parallel to the direction of the flow of the information. In column 13 line 4, an applied 6000 volts is used to invert the logic.

### SUMMARY OF THE NEW ART

Light signals enter two fiber optic channels. The first fiber optic channel is A of the optical logic gate providing the first digital data light input. The second fiber optic channel is B of the optical logic gate providing the second digital data light signal input. In both fiber optic channels (A and B) the input signal is amplified. The light is then split with one path going to a switch the other to a frequency doubler. The frequency doubled light channel is joined with the opposite input channel after the amplifier. The joined light paths then enter a switch and merge as a single output. This provision of one pulse only when both A and B inputs are in opposite states will provide light as the output.

The data light pulse is divided into two channels. The light in the channels are amplified in power to boost their power back to standard data pulse level. In both channels, there is a split the data pulse is doubled in frequency in the split and is routed to the opposite channel. After the intersection on each channel, the data pulse is routed through a light filter switch then two channels are then combined, and data light signal will be off if they are both present. In the present invention, no electrical control is required as Skogen's device does. The speed of the present new art data light extinguishing is much faster than nanoseconds. No applied voltage is needed. All of this is accomplished in a fiber optic channel and parallel to the path of data unlike Ullrich's device which requires reflecting at some angle from the normal to function. The present invention also does not require 6000 volts to accomplish its function as Ullrich's does. Semiconductor circuits are killed by voltages as high as 6000 volts.

### BRIEF DESCRIPTION OF DRAWINGS

FIG. 1 shows an OR gate truth table

FIG. 2 shows a XOR gate truth table

FIG. 3 shows an optical schematic of the present inventions OR gate

FIG. 4 shows an optical schematic of the present inventions XOR gate

FIG. 5 shows a depiction of the atomic structure of the present invention's optical amplifier for optical signals

FIG. 6 shows a depiction of the atomic structure the present inventions data signal to control signal converter

FIG. 7 shows a depiction of the present inventions DLEs atomic structure and light interaction

FIG. 8 shows a depiction of the present inventions filter for half powered light signals

### DETAILED DESCRIPTION OF NEW ART

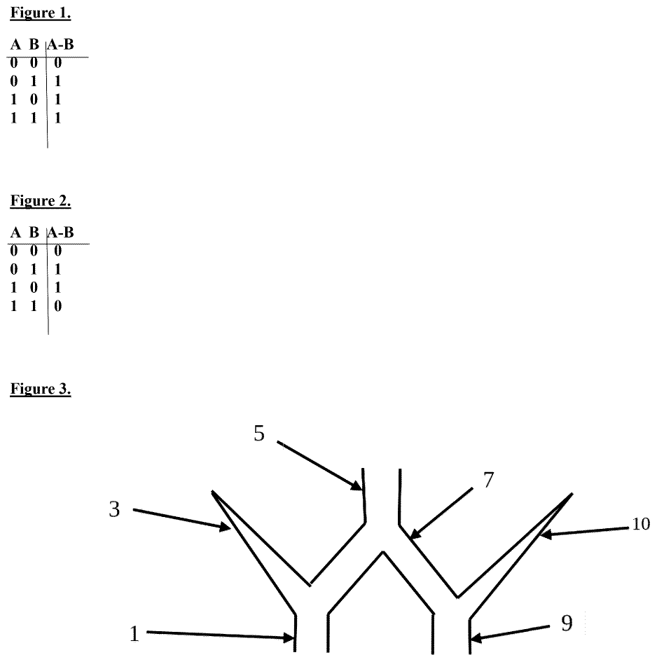

FIG. 1 shows a truth table for an OR gate. As seen in the truth table, when no light pulse enters both logic gate input channels A and B, the result is that no light signal or “1” comes out of the OR gate. When a light pulse enters gate input channel A and no light pulse or “1” enters gate input channel B, then a light signal or “1” comes out of the OR gate. The same is true if a light pulse enters gate input channel B and no light pulse enters or “1” gate input channel A, then a light signal or “1” comes out of the OR gate. And when a light pulse enters both A and B gate input channels does a light pulse or “1”come out of the OR gate.

FIG. 2 shows a truth table for a XOR gate. When no light pulse enters both gate input channels A and B the result is no light pulse or “1” coming out of the XOR gate. If a light pulse enters either input channels A or B with no input pulse entering the other one, then a light pulse or “1” will come out of the XOR gate. If an input data signal goes into both input channels A and B does the XOR gate produce no output a “0”light pulse.

FIG. 3 shows the present inventions OR gate. Feature 1 is the A input for the OR gate pictured in FIG. 3. Feature 5 of FIG. 3 it is the OR output. Feature 9 in FIG. 3 is input B for the OR gate pictured in FIG. 3.

The OR gate in FIG. 3 takes in standard energy data light. The light channels A and B are then recombined to produce the output data pulse. When either input channel A or B contributes a standard energy pulse the OR gate produce a standard energy pulse. This gives the result of the truth table shown in FIG. 1.

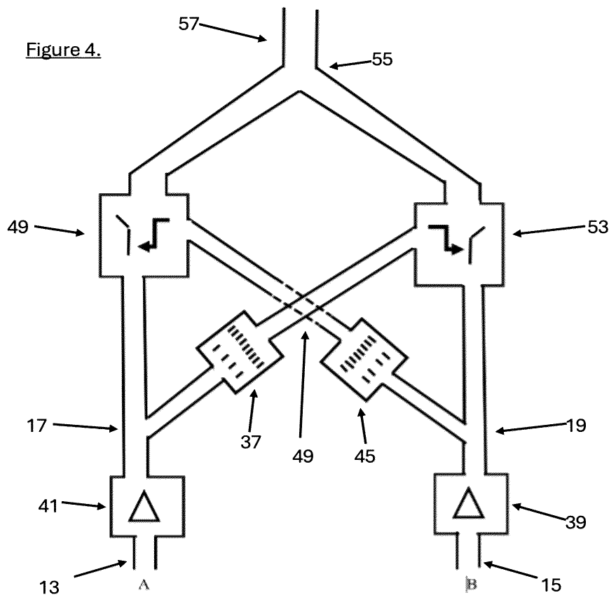

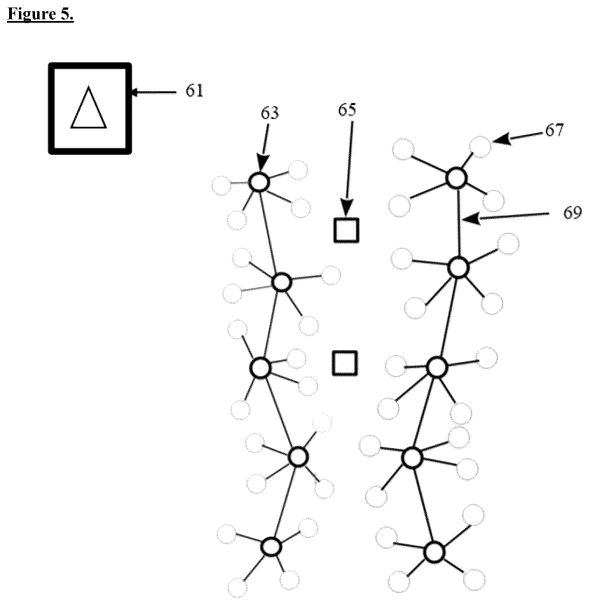

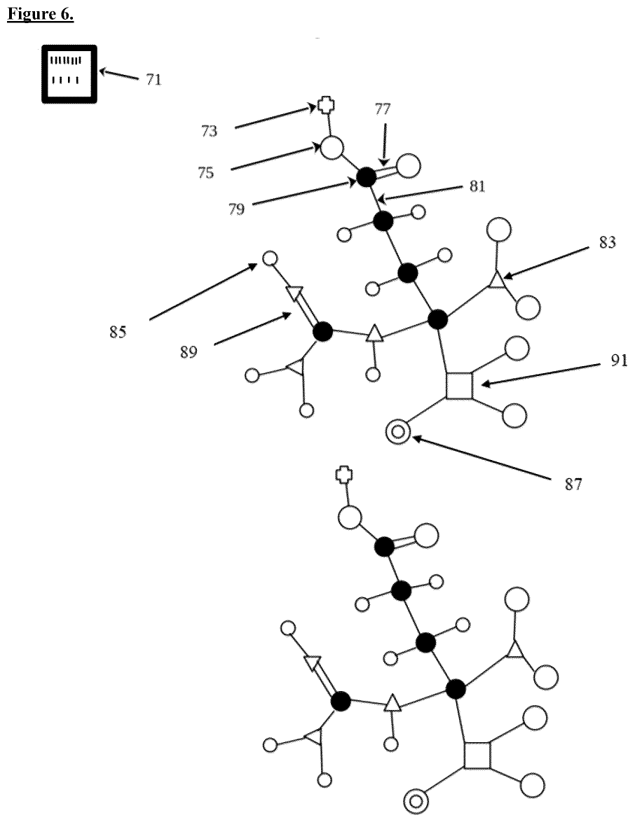

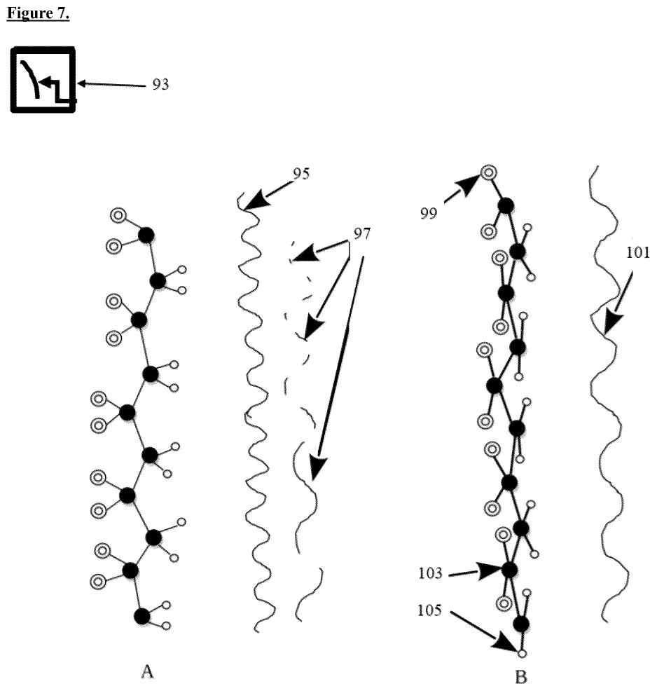

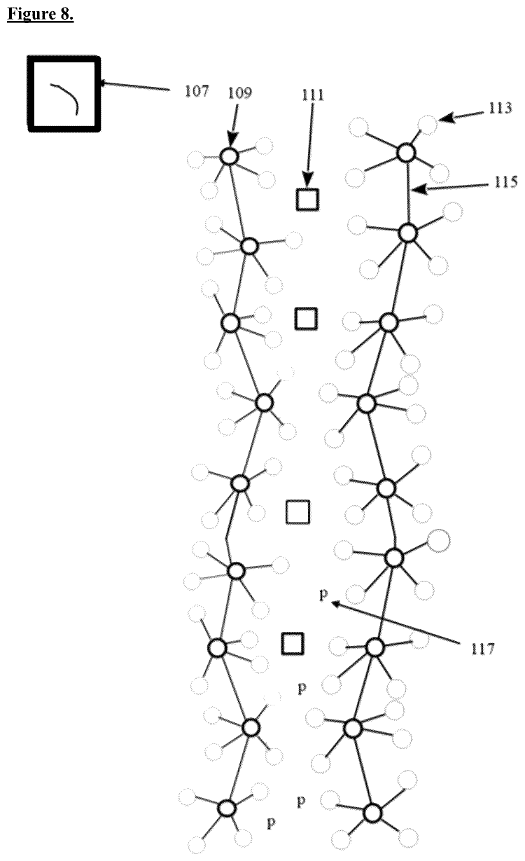

FIG. 4 is a schematic drawing of the XOR gate to be patented. In FIG. 4, features 13 and 15 are the entrance gates for light signals for said XOR gate. Feature 13 is the A data gate for said XOR gate. Feature 15 is the B data gate for said XOR gate. For illustration, let there be an input data of 00011100 coming into data gate A, and an input data of 00110000 coming into the data gate B. The output for the XOR gate of the present invention, which Feature 57 of FIG. 4, would then be 00101100. Only on the fourth data input do both A and B have a data signal of one. The XOR logic excludes the signal that is A and B simultaneously. The XOR only gives one output when either A or B have a one input.

Features 17 and 19, are data light splitters. The data coming into Features 13 and 15 respectively are split to provide signal for the right-angle Data Light Extinguisher (DLE,) Features 53 and 49 respectively. In this description of this invention, the term data light has been used to describe a light carrying information. In this description, control light will be used to indicate higher frequency light used to extinguish data light.

Feature 37 changes the data light signal into a control light signal. Feature 37 is a frequency doubler. Feature 53 is a right-angle data light extinguisher that acts so that when the data light from light splitter 19 passes through said right angle data light extinguisher 53 and control light from frequency doubler 37 is present the data light from light splitter 19 is extinguished. The control light from Feature 37 extinguishes the light from Feature 19 to leave zeros “0” in the light precisely where there was a one “1” data light pulses in the data from the combined data from inputs A and B. So, when there is an input pulse, the frequency doubler Feature 37, makes it zero through the right-angle data light extinguisher 53. In this embodiment of said XOR gate, doubled frequencies are used. In an alternative embodiment, other higher frequencies may be used. A 10 percent or 20 or other percentage higher frequencies may be used for the switching light. These frequencies may be provided by Raman Scattering of light to a higher frequency form the data light frequency.

Feature 45 changes the data light signal into a control light signal. Feature 45 is a frequency doubler. Feature 49 is a right-angle data light extinguisher that acts so that when the data light from light splitter 17 passes through said right angle data light extinguisher 49 and control light from frequency doubler 45 is present the data light from light splitter 17 is extinguished. The control light from Feature 45 extinguishes the light from Feature 17 to leave zeros “0” in the light precisely where there was a one “1” data light pulses in the data from the combined data from inputs A and B. So, when there is an input pulse, the frequency doubler, Feature 45, prevents propagation of the data light through the waveguide, thereby resulting in no output into the right-angle data light extinguisher 49. In this embodiment of said XOR gate, doubled frequencies are used. In an alternative embodiment, other higher frequencies may be used. A 10 percent or 20 or other percentage higher frequencies may be used for the switching light. These frequencies may be provided by Raman Scattering of light to a higher frequency form the data light frequency.

The light channels are composed of higher index of refraction transparent material, and the channels are covered with lower index of refraction material to ensure total internal reflection. The dimensions of the light channels are chosen so that the data light is near the cutoff frequency for the data light. When the piezoelectric features of the said right-angle DLEs are actuated by the control light, the light channel becomes too small for the data light, and it is cutoff.

Features 39 and 41 are optical amplifiers for the peaks coming from the inputs 13 and 15 for the input part of said XOR gate. Features 45 and 37 are frequency doublers that turn data signal light to control signal light for the light pulses coming from data inputs Features 13 and 15 of said XOR gate. Features 45 and 37 are frequency doublers changing data signal light to control signal light converter that makes the data light into a control light with twice the frequency as the data light. If the data light has a frequency, for example of 1.92E14 hertz (Hz) and a wavelength of 1560 nm, then the data light to control signal converter will change the data light into control light with a frequency for example of 3.85E14 Hz and a wavelength of 780 nm. Features 53 and 49 are right-angle DLEs. The control light in the data light extinguisher causes a piezoelectric material to rise and choke out the data light. This allows a “1” in the data signal to be changed to a “0” data signal. The control light must be a higher frequency than the data light. In this embodiment the said XOR gate the frequency is doubled, but in alternative embodiment a 10 percent higher frequency or 20 percent or other higher frequency may be used.

In the function of an OR gate, a signal from Features 13 or 15 will go out as an output of the OR gate, also when a signal comes from both 13 and 15 that signal will go out as an output for the OR gate. In the present invention, when signals come from both 13 and 15, the light of the data light from 13 is doubled in Feature 37 to go into right-angle data light extinguisher 53 to tun off the data light from 15. At the same time the data light from 15 is doubled through Feature 45 to go into right-angle data light extinguisher 49 to turn off the data light from 13. This way the present invention does not have a data light pulse coming out if a pulse comes into both 13 and 15. This gives the desired XOR gate function. Only when data pulses come only from 13 or 15 alone, not together, that a data pulse comes out of the output at Feature 57.

Feature 43 is a crossing of light channels that does not allow the light of either channel to influence or mingle with the light of the other channel. Feature 55 is a light combiner that joins the light from right-angle DLEs 53 and 49.

In United States Patent 20240411203 published by Del dle and Kevin Bylow which teaches PURELY OPTICAL LOGICAL NAND GATE WITH COMPRISING MATERIALS, the data light extinguisher uses colinear switching light to extinguish the data light. Patent 20240411203 is here incorporated by reference. The data light extinguisher in the present invention is a right-angle data light extinguisher where the control light shines across at a right-angle to the data light that it is extinguishing. The drawings provided in this disclosure are schematic only and actual equipment will have other features that are not necessary to the understanding of the present invention.

I claim as my invention:

1. A purely optical XOR logic gate comprising:
a first optical input channel (A) and a second optical input channel (B), each formed from a high-index fiber optic waveguide surrounded by lower-index cladding to maintain total internal reflection;
an optical amplifier positioned in each input channel to increase the power of incoming data light signals;
an optical splitter in each input channel configured to divide the data light into a primary path and a secondary path;
a frequency doubler in each secondary path configured to convert the data light signal into a control light signal having a frequency at least twice that of the corresponding data light signal;
a first right-angle Data Light Extinguisher (DLE) disposed in the primary path of input channel B, intersected at a right angle by the control light from the secondary path of input channel A, the first DLE configured to extinguish the data light in channel B when the control light is present;
a second right-angle DLE disposed in the primary path of input channel A, intersected at a right angle by the control light from the secondary path of input channel B, the second DLE configured to extinguish the data light in channel A when the control light is present;
an optical combiner for merging the outputs of the primary paths from both channels into a single output channel, such that the output channel carries a light signal only when exactly one of the input channels A or B carries a data light pulse.

2. The purely optical XOR gate of claim 1, wherein the control light signal generated by each frequency doubler has a wavelength approximately one-half that of the corresponding data light signal.

3. The purely optical XOR gate of claim 1, wherein the control light signal generated by each frequency doubler has a wavelength between 10% and 20% shorter than the wavelength of the corresponding data light signal.

4. The purely optical XOR gate of claim 1, wherein the right-angle Data Light Extinguisher comprises a piezoelectric optical waveguide segment configured to deform under illumination by the control light, thereby inducing a waveguide cutoff condition for the corresponding data light signal.

5. The purely optical XOR gate of claim 1, wherein the frequency doubler is implemented by a nonlinear optical medium exhibiting second harmonic generation or Raman scattering to produce the control light signal.
